(19) United States
(12) Patent Application Publication
(10) Pub. No.: US 2007/0063977 A1
(43) Pub. Date: Mar. 22, 2007

(54) Keyboard with a camera

(75) Inventor: Diamond Kuo, Taipei (TW)

Correspondence Address: QUINTERO LAW OFFICE, PC, 2210 MAIN STREET, SUITE 200, SANTA MONICA, CA, 90405, US

(73) Assignee: LIFE-ON TECHNOLOGY CORPORATION, TAIPEI (TW)

(21) Appl. No.: 11/356,819

(22) Filed: Feb. 17, 2006

(30) Foreign Application Priority Data
Sep. 19, 2005 (TW) TW94216103

(51) Int. Cl. G09G 5/00

(52) U.S. Cl. 345/168

(57) ABSTRACT

A keyboard with a camera comprises a plurality of general keys, a plurality of hot keys, a keyboard module, a hot key module and a camera module. The keyboard module outputs corresponding messages in response of the input of the general keys. The hotkey module outputs corresponding instructions in response of the inputs of the hot keys. The camera module coupled to the hotkey module operates in response of the instructions and transmits operating results to a computer.

### BACKGROUND

The invention relates to a keyboard and more particularly to a keyboard with a camera.

With the growth of broadband networks, an increasing number of people use webcams to communicate over the internet. FIG. 1 is a schematic diagram of a conventional method of using a webcam. The user utilizes an external webcam 14 coupled to a computer host 12 and operates an application program via a keyboard 13 or mouse (not shown in FIG. 1) to show frames captured by the webcam 14. According to the method of FIG. 1, the user must buy an external webcam, such as webcam 14, and this causes consumer extra connection cables and occupies space. Furthermore, the user can only control the webcam 14 by using the corresponding application program. Moreover, to no additional hotkeys are available on webcam 14 or keyboard 13 causing inconvenience.

### SUMMARY

The invention provides a keyboard with a camera comprising a plurality of general keys, a plurality of hot keys, a keyboard module, a hot key module and a camera module. The keyboard module outputs corresponding data in response to the input of the general keys. The hotkey module outputs corresponding instructions in response to the input of the hotkeys. The camera module coupled to the hotkey module operates in response to the instructions and transmits results to a computer.

### DESCRIPTION OF THE DRAWINGS

FIG. 1 is a schematic diagram of a conventional method of using a webcam.

FIG. 2 is a schematic diagram of a computer system using a keyboard with a camera of an embodiment of the invention.

FIG. 3 shows a functional diagram of the embodiment of the invention.

FIG. 4 is a keyboard of an embodiment of the invention.

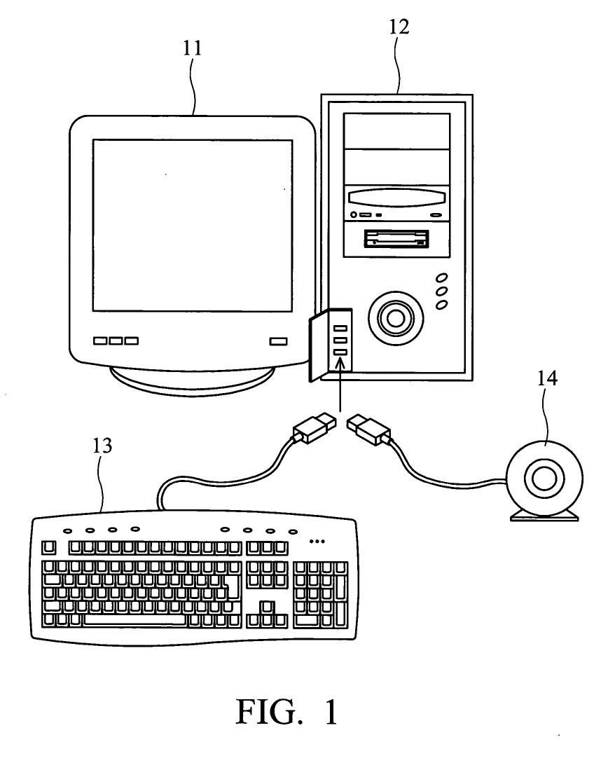

### DETAILED DESCRIPTION

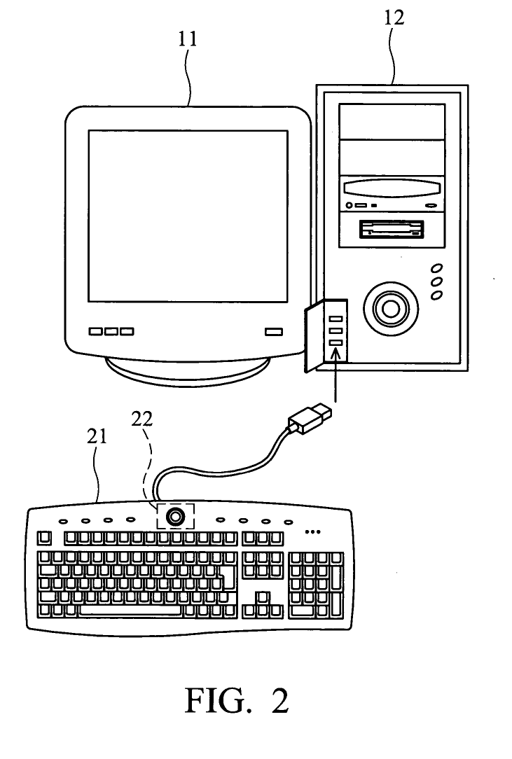

FIG. 2 is a schematic diagram of a computer system using a keyboard with a camera of an embodiment of the invention. To improve issues arising from the external webcam, a keyboard 21 with a built-in camera 22 is provided. In FIG. 2, the keyboard 21 and the camera 22 have the same interface, such as USB, PS/2 or others, and thus the keyboard 21 and the camera 22 can use the same connecting cable to connect the computer host 12.

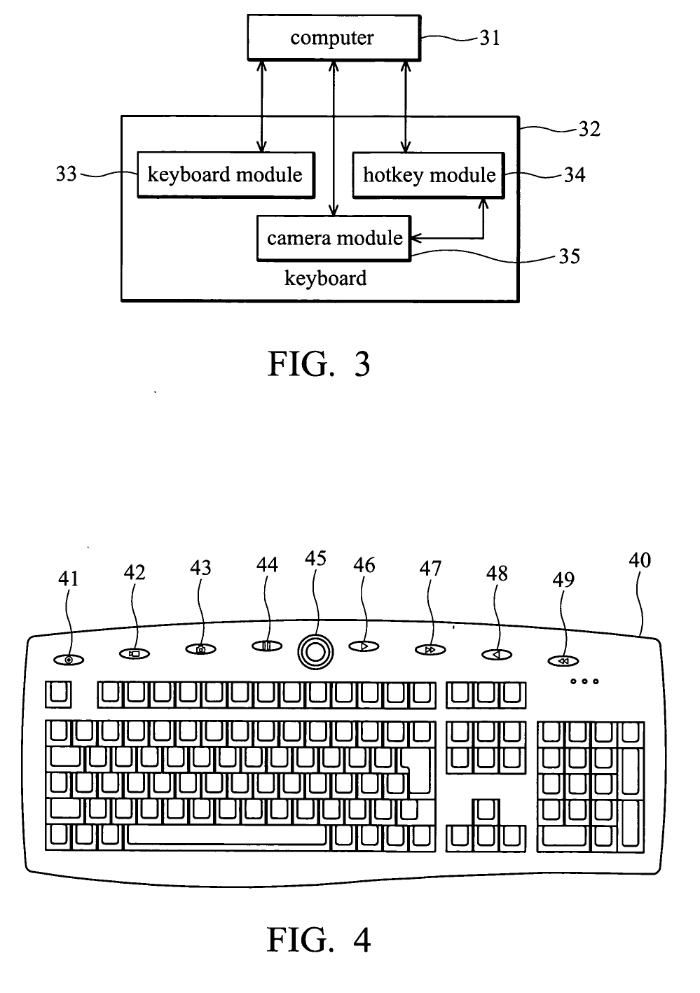

FIG. 3 is a functional diagram of a computer system using a keyboard of an embodiment of the invention. The keyboard 32 comprises a plurality of general keys (not shown in FIG. 3), a plurality of hotkeys (not shown in FIG. 3), a keyboard module 33, a hotkey module 34 and a camera module 35. The keyboard module 33 transmits the input data in response to the input from the general keys of the keyboard 32 to the computer 31. The hotkey module 34 controls the camera 35 through the input of the hotkeys and transmits the input data to the computer 31. In the invention, camera comprises a CCD module or a CMOS module. The camera module 35 can be controlled by hardware, such as the hotkeys of the keyboard 32, or an application program, such as video software.

FIG. 4 is a keyboard of an embodiment of the invention. Keyboard 40 with a built-in webcam 45 has a plurality of hotkeys, such as keys 41˜44 and 46˜49 and the webcam 45 is directly controlled by the hotkeys. Power key 41 is operable to turn on the power of the webcam 45 and the application program of the computer operating system. Video recoding key 42 is operable to turn on the video recoding function of the webcam 45 and the application stores the frames captured by the webcam 45. Shutter key 43 is operable to turn on the photographing function of the webcam 45. When the shutter key 43 is pressed, the application stores the frame captured by the webcam 45. Pause key 44 is operable to stop or restart the operation of the webcam 45. The webcam 45 stops working when the pause key 44 is pressed, and restarts when the pause key 44 is pressed again. Playback key 46 is operable to play the media data stored through the video recoding function of the webcam 45. Forward key 47 is operable to play the media data stored through the video recoding function of the webcam 45 enabling easy location of the image at a specific time. Reverse key 48 is operable to lay the media data stored through the video recording function of the webcam 45 in reverse. The fast reverse key 49 key 47 is operable to play the media data in reverse at an accelerated speed.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A keyboard with a camera, comprising:
a plurality of general keys;
a plurality of hot keys;
a keyboard module outputting corresponding messages in response of the input of the general keys;
a hotkey module outputting corresponding instructions in response of the inputs of the hot keys; and
a camera module coupled to the hotkey module operating in response of the instructions and transmitting operating results to a computer.

2. The keyboard as claimed in claim 1, wherein the camera module is a CCD camera module.

3. The keyboard as claimed in claim 1, wherein the camera module is a CMOS camera module.

4. The keyboard as claimed in claim 1, wherein the hot keys comprises a power key, a video recording key and a shutter key.
